(19) United States
(12) Patent Application Publication
(10) Pub. No.: US 2007/0090896 A1
(43) Pub. Date: Apr. 26, 2007

(54) Simplified phase shifter

(75) Inventor: Sven-Erik Elfgren, Mölndal (SE)

Correspondence Address: NIXON & VANDERHYE, PC, 901 NORTH GLEBE ROAD, 11TH FLOOR, ARLINGTON, VA, 22203, US

(73) Assignee: TELEFONAKTIEBOLAGET LM ERICSSON (PUBL), Stockholm (SE)

(21) Appl. No.: 10/582,234

(22) PCT Filed: Dec. 18, 2003
(86) PCT No.: PCT/SE03/01990

§ 371 Date: Jun. 9, 2006

(51) Int. Cl. H01P 9/00; H01P 3/00

(52) U.S. Cl. 333/164

(57) ABSTRACT

The invention discloses a phase shifter (200, 300) for an electrical signal, comprising input means for said signal, additionally comprising first (120) and second (130) alternative signal paths, the second signal path being achieved by means of an additional signal path (130) which has both its starting and ending point at the first signal path (120), there being a predetermined difference in electrical length between the signal paths, the phase shifter comprising means (240, 242, 243; 340, 342) for closing and opening one of the two signal paths at a time. The means (242, 342) for closing and opening the first signal path is a single switch located at a point in the first signal path between the starting and ending points of the additional signal path, with the electrical distance between said starting and ending points, apart from that occupied by said switch, being virtually zero.

### TECHNICAL FIELD

The present invention relates to phase shifters for electrical signals. By means of the invention, a simplified phase shifter can be obtained.

### BACKGROUND ART

Phase shifters are a common component in many electronics systems, such as, for example, phased array antenna systems.

### DISCLOSURE OF THE INVENTION

Since phase shifters are such common components, there is a great interest in designing them in as cost efficient a way as possible.

This interest is addressed by the present invention, in that it discloses a phase shifter which comprises input means for an electrical signal, and which also has a first and a second alternative signal path.

The second signal path is achieved by means of an additional signal path which has both its starting and ending point at the first signal path, there being a predetermined difference in electrical length between the signal paths.

The phase shifter also comprises means for closing and opening one of the two signal paths at a time, and the means for closing and opening the first signal path is a single switch located at a point in the first signal path between the starting and ending points of the additional signal path, with the electrical distance between the starting and ending points, apart from that occupied by said switch, being virtually zero.

As will become apparent from the detailed description below, this can result in a more cost saving design than previously.

### BRIEF DESCRIPTION OF THE DRAWINGS

The invention will be described in more detail in the following, with reference to the appended drawings, in which:

FIG. 1 shows a previously known phase shifter, and

FIG. 2 shows a first embodiment of a phase shifter according to the invention, and

FIG. 3 shows a second embodiment of a phase shifter according to the invention, and

FIG. 4 shows a third alternative embodiment of the invention.

### EMBODIMENTS

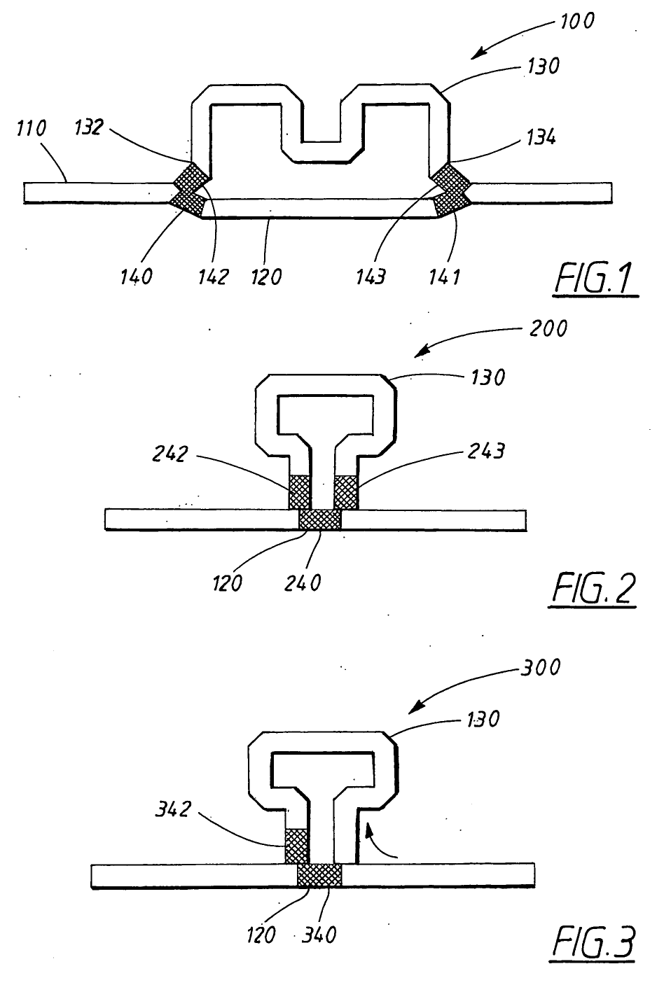

In FIG. 1, for the sake of clarity, a previously known kind of phase shifter 100 in microstrip technology is shown. For reasons that will become obvious, this kind of phase shifter is known as a switched line phase-shifter.

The phase shifter 100 has input means 110 for an electrical signal that is to be phase shifted. As can be, seen from the figure, the phase shifter comprises a first 120 and a second 130 alternative signal path for the signal. The difference in electrical length between the two signal paths corresponds to the phase shift which it is desired to obtain. Naturally, the electrical length will depend on the frequency of the signal.

As can also be seen in FIG. 1, the longer of the two alternative signal paths is achieved by means of an additional signal path 130 which has both its starting 132 and ending 134 point at the first (shorter) signal path. Thus, the phase shift could be said to be achieved by means of forcing the signal to take a “detour” 130, with an electrical length that corresponds to the desired phase shift, as an alternative to the signal using a “straight line” 120, i.e. the first signal path.

In order to make the signal take either of the two paths, the phase shifter comprises means 140-143 for closing and opening one of the two signal paths at a time. These are shown in FIG. 1 by lighter lines than the rest of the device, and are constituted by four switches, one at each of the ending and starting point of the additional length used for the second signal path, and one at each of the “ends” of the first path which is between the “attachment points” of the additional length.

These switches are such that they can be controlled to be either in an “open” or a “closed” state. In the “open” state, a switch will have low or zero series impedance, and in the “closed” state a switch will have a large or infinite series impedance.

When it is desired to let the signal take the longer path 130, the switches 140, 141 are closed, and the switches 142, 143 are opened. Conversely, when the signal is not to be phase shifted, the switches 140,141 are opened and 142, 143 are closed, allowing the signal to pass through the straight line 120.

A common component for realizing the switches is so called PIN-diodes. As can be seen from the explanation above and from FIG. 1, four PIN-diodes will be needed for the phase shifter of FIG. 1. As an alternative to PIN-diodes, transistor switches can also be used.

In FIG. 2, a first embodiment of a phase shifter 200 according to the invention is shown: in arriving at the invention, it has been realized that one of the switches in the first signal path is actually unnecessary. Consider the embodiment 200 shown in FIG. 2: the first signal path, “the straight line”, is made as close to zero as possible. In fact, it is only made long enough to be able to accommodate one single switch 240. The two switches 242, 243, used for opening and closing the second signal path 130 in the embodiment shown in FIG. 1 are also used in this embodiment.

Now, only three switches will be needed. If it is desired for the signal to use the second signal path 130, i.e. to obtain a phase shift, the switch 240 in the “straight path” is closed and the other two, 242, 243, are opened.

Conversely, if it is desired for the signal to use the first signal path, i.e. no phase shift, the switch 240 in the “straight path” is opened and the other two, 242, 243, are closed.

The invention also discloses another way of opening/closing the second signal path 130, the “detour”, by means of which a phase shift is obtained.

Consider the embodiment shown in FIG. 3: it is similar to the one shown in FIG. 2, but has only one switch 342 for opening/closing the additional length 130, “the detour”. This switch is suitably positioned at one of the “attachment points” of the additional length to the straight line, i.e. at one of the ends of the additional path 130.

When it is desired for the signal to pass through the additional length 130, i.e. to take the second signal path and thus to achieve a phase shift, the single switch 342 in the additional length 130 is opened, and the single switch 340 in the “straight line” 120, i.e. the first signal path, is closed.

When, conversely, it is desired not to obtain a phase shift, the switch 342 to the second signal path 130 is closed, and the switch 340 in the first signal path 120 is opened. The signal can however not pass the way indicated by an arrow in FIG. 3, the way which would have been closed by the second switch in the additional length of FIG. 3. This is by virtue of the fact that the electrical length of the additional length 130 for a certain predetermined desired frequency is 180 degrees, i.e. one half of a wave length. With the additional length having this electrical length, and with the switch 342 at the opposite end of the additional length 130 being closed, the impedance of the additional length 130 as seen from the point previously occupied by the second switch is virtually infinite, meaning that the second path is effectively closed at this point.

Thus, by means of the invention, one (the embodiment of FIG. 2) or even two (the embodiment of FIG. 3) diodes can be saved, as compared to conventional switched line phase-shifters, which of course is cost saving.

In addition, some other advantages offered by the invention that can be mentioned are that the insertion loss will be lower with the one-diode or two-diode solution as compared to a standard four-diode switched line phase-shifter.

Also, the phase-shift variation from 180 degrees in a given frequency band will be less than with the conventional phase shifter, in which the variation can be from 169 to 191 degrees, whereas it has been experimentally shown that it will only vary from 175 to 185 degrees in the solutions of the invention.

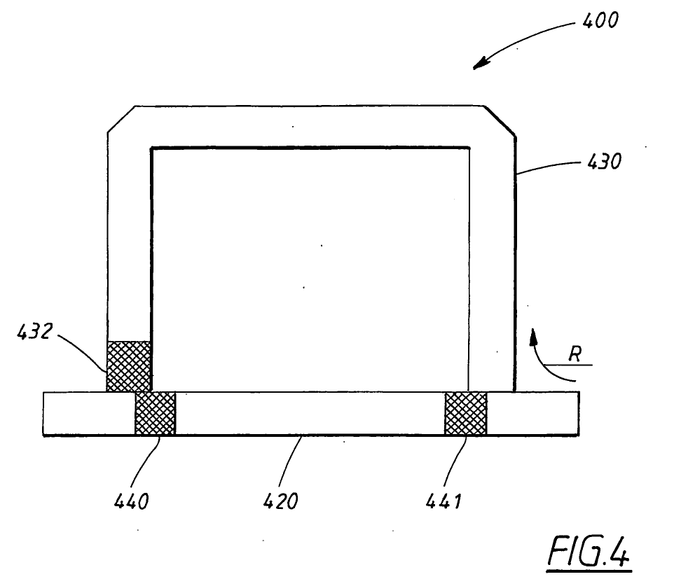

Finally, in FIG. 4, another embodiment 400 of the invention is shown. In similarity to the embodiment 300 shown in FIG. 3, this embodiment utilizes the fact that a conductor which has a length of 180 degrees for a certain wavelength has a virtually infinite impedance for that wavelength. The embodiment 400 comprises a straight line 420 with a length with a certain extension, i.e. not zero, and a second signal path, an additional length 430, which attaches to the straight line at a starting point and at a finishing point.

The additional length 430 comprises one switch, 432 at its starting point, and the straight line comprises a switch 440, 441, at both the starting point and the finishing point.

Thus, when it is desired to let the signal pass through the device 400 with no phase shift, the switches 440 and 441 are opened, and the switch 432 is closed. There is now no switch closing off the path shown with an “R” in FIG. 4, i.e. the path from the finishing point of the additional length 430 into the additional length. However, since the impedance of the additional length 430 is infinite at the frequency used when the switch 432 is closed, the signal can't pass through this way.

In conclusion, the length of the straight line in the embodiment 400 doesn't matter, meaning that any phase difference between the straight line 420 and the additional length 430 can be obtained in this embodiment.

1. A phase shifter for an electrical signal, comprising input means for said signal, additionally comprising first and second alternative signal paths, the second signal path being achieved by means of an additional signal path which has both its starting and ending point at the first signal path, there being a predetermined difference in electrical length between the signal paths, the phase shifter comprising means for closing and opening one of the two signal paths at a time, characterised in that the means for closing and opening the first signal path is a single switch located at a point in the first signal path between the starting and ending points of the additional signal path, with the electrical distance between said starting and ending points, apart from that occupied by said switch, being virtually zero.

2. The phase shifter of claim 1, in which the means for closing and opening the second signal path comprises two switches, one at either end of the second signal path.

3. The phase shifter of claim 1, in which the means for closing and opening the second signal path are achieved by means of a single switch located at one of the ends of the additional path, and by virtue of the predetermined difference in electrical length between the signal paths being essentially 180 degrees of a wave length for which the phase shifter is intended.

4. The phase shifter of claim 1, in which the switches mentioned are PIN-diodes.

5. The phase shifter of claim 1, in which the switches mentioned are transistor switches.
